(19) United States
(12) Patent Application Publication
(10) Pub. No.: US 2013/0240161 A1
(43) Pub. Date: Sep. 19, 2013

(54) METHOD OF MAKING A WINDOW BLIND COMPONENT

(71) Applicant: TAICANG KINGFU PLASTIC MANUFACTURE CO., LTD., Taicang (CN)

(72) Inventor: Szu-Chang Huang, Changhua County (TW)

(73) Assignee: TAICANG KINGFU PLASTIC MANUFACTURE CO., LTD., Taicang (CN)

(21) Appl. No.: 13/875,960

(22) Filed: May 2, 2013

Related U.S. Application Data
(62) Division of application No. 12/987,243, filed on Jan. 10, 2011.

(30) Foreign Application Priority Data
Jan. 29, 2010 (CN) 201010110711.6

(51) Int. Cl. E06B 9/386

(52) U.S. Cl. CPC E06B 9/386
USPC 160/236; 160/405; 160/368.1; 156/250

(57) ABSTRACT

A window blind component includes a stack of paper fiber sheets, and an adhesive bonding said paper fiber sheets together, each of said paper fiber sheets includes 91-95% by weight of paper pulp, 3-5% by weight of a binder, and 2-4% by weight of a water repellent. The adhesive includes an acrylate polymer, the binder includes ethylene glycol dimethyl acrylate polymer, and the water repellent includes an acrylic acid polymer. The window blind component is a blind slat, the number of the paper fiber sheets in the stack is 20-40, and each of the paper fiber sheets has a thickness ranging from 0.08-0.12 mm.

### CROSS REFERENCE TO RELATED APPLICATIONS

This is a divisional application of U.S. application Ser. No. 12/987,243 filed on Jan. 10, 2011, which claims priority of Chinese Patent Application No. 201010110711.6 filed on Jan. 29, 2010. This application claims the benefit and priority of these prior applications and incorporates the disclosures of these prior applications by reference in their entirety.

### BACKGROUND OF THE INVENTION

1. Field of the Invention

The invention relates to a window blind component, and more particularly to a material and method for making a window blind component.

2. Description of the Related Art

Early window blind components, such as blind slats, are typically made by stamping thin sheets of metals, such as aluminum or aluminum alloys, into a curved shape, followed by surface treatment to apply a baked coating on the thin sheets. Such window blind components are costly, heavy and inconvenient for manipulation. In addition, because such window blind components are thermally conductive, they have poor heat dissipation properties and are prone to absorb heat from sunlight.

Plastic blind slats have advantages of being light weight and being easy to operate. However, because the plastics, such as polyvinylchloride, used to make the conventional plastic blind slats are not biodegradable, and can release toxic substances, conventional plastic blind slats are not suitable for recycling and can cause environmental problems.

### SUMMARY OF THE INVENTION

An object of the present invention is to provide a window blind component that is environmentally friendly and that can be fabricated using recycled waste.

According to one aspect of the present invention, a method of making a window blind component comprises:

(a) preparing a plurality of paper fiber sheets;

(b) applying an adhesive to each of the paper fiber sheets;

(c) stacking the paper fiber sheets together with the adhesive to form a stack, followed by press forming the stack to produce a paper fiber composite material;

(d) heating and drying the paper fiber composite material and cutting the same into a blank; and

(e) forming the blank into the window blind component.

According to another aspect of the present invention, a window blind component comprises a stack of paper fiber sheets, and an adhesive bonding the paper fiber sheets together. Each of the paper fiber sheets includes 91-95% by weight of paper pulp, 3-5% by weight of a binder, and 2-4% by weight of a water repellent.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram illustrating a method of making a window blind component according to a preferred embodiment of the present invention; and

FIG. 2 is a sectional view illustrating the window blind component according to the preferred embodiment of the present invention.

### DETAILED DESCRIPTION OF THE PREFERRED EMBODIMENTS

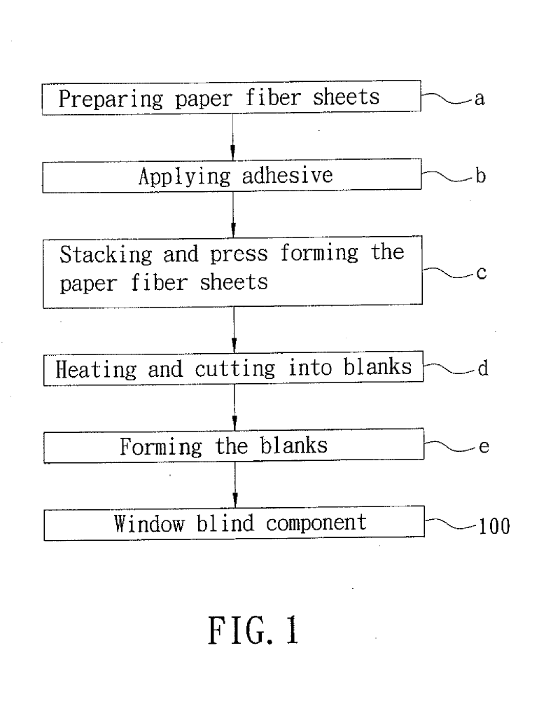

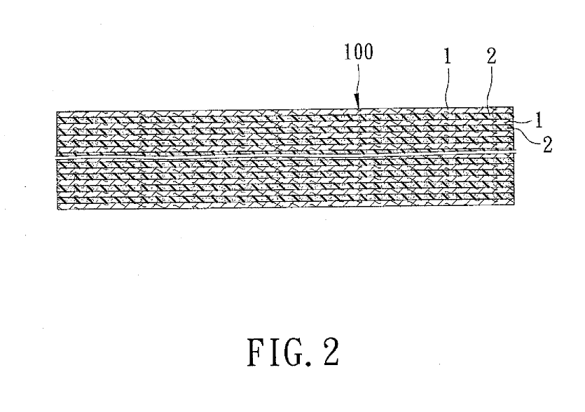

Referring to FIGS. 1 and 2, a method of making a window blind component 100 according to a preferred embodiment of the present invention includes the following steps:

In step (a), a plurality of paper fiber sheets 1 are prepared. The paper fiber sheets are prepared from a material that includes a paper pulp as a main component, and further includes a binder and a water repellent. The paper pulp is mixed with the binder and the water repellent and formed into the paper fiber sheets 1.

The paper pulp may be ground wood pulp, chemical pulp or semi-chemical pulp. The binder may include an acrylate polymer. In a preferred embodiment, the binder includes ethylene glycol dimethyl acrylate polymer, and the water repellent includes an acrylic acid polymer. Preferably, the material includes 91-95% by weight of the paper pulp, 3-5% by weight of the binder, and 2-4% by weight of the water repellent.

To save resources and to protect environment, the paper pulp may be one that is recycled from waste paper.

In step (b), an adhesive 2 is applied to each of the paper fiber sheets 1. Preferably, the adhesive 2 includes an acrylate polymer, and may be applied to the paper fiber sheets 1 by spray coating, spread coating or brush coating.

In step (c), the paper fiber sheets 1 that have been coated with the adhesive 2 are arranged in a stack and are formed into a paper fiber composite material through a press forming process. The number of the paper fiber sheets 1 used in the stack depends on the configuration of the window blind component 100 to be produced.

If the window blind component 100 is a window blind slat, the number of the paper fiber sheets 1 may be 20-40, and the thickness of each paper fiber sheet 1 may be 0.08-0.12 mm. The stack of the paper fiber sheets 1 may have a thickness of 3.1-3.2 mm after being press formed.

If the window blind component 100 is a headrail of a window blind, the number of the paper fiber sheets 1 may be 40-60, and the thickness of each paper fiber sheet 1 may be 0.08-0.12 mm. The stack of the paper fiber sheets 1 may have a thickness of 3.2-3.3 mm after being press formed.

If the window blind component 100 is a bottom rail of a window blind, the number of the paper fiber sheets 1 may be 80-120, and the thickness of each paper fiber sheet 1 may be 0.08-0.12 mm. The stack of the paper fiber sheets 1 may have a thickness of 3.4-3.6 mm after being press formed.

In step (d), the paper fiber composite material is heated to dry and cut into blanks.

In step (e), the blanks are trimmed and formed into the window blind components 100. The window blind component 100 may be a blind slat, a headrail of a window blind or a bottom rail of a window blind.

The method of the present invention may further includes the step of adding a functional material to the mixture of the paper pulp, the binder and the water repellent in order to increase utility value of the window blind component 100. The functional material may be an anti-ultraviolet agent , a flame-retarding agent, or a combination thereof. With the functional material, the window blind component will impart ultraviolet-resisting and anti-fire properties and will have high durability.

Moreover, the method of the present invention may additionally include the step of coloring and decorating the window blind component 100, after the step (e).

Referring back to FIG. 2, the window blind component 100 includes a plurality of paper fiber sheets 1 and layers of an adhesive (2). Each paper fiber sheet 1 includes a paper pulp, a binder and a water repellent. In an embodiment, each paper fiber sheet 1 includes 91-95% by weight of the paper pulp, 3-5% by weight of the binder and 2-4% by weight of the water repellent.

Because the window blind component 100 is made from natural paper fiber or recycled waste paper, it meets the requirements of environmental protection. In addition, because the paper fiber sheets 1 include the water repellent and the binder and are dried under heat, the window blind component made therefrom has high durability and high resistant to moisture.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A window blind component, comprising a stack of paper fiber sheets, and an adhesive bonding said paper fiber sheets together, each of said paper fiber sheets includes 91-95% by weight of paper pulp, 3-5% by weight of a binder, and 2-4% by weight of a water repellent.

2. The window blind component of claim 1, wherein the adhesive includes an acrylate polymer, the binder includes ethylene glycol dimethyl acrylate polymer, and the water repellent includes an acrylic acid polymer.

3. The window blind component of claim 1, wherein the window blind component is a blind slat, the number of the paper fiber sheets in the stack is 20-40, and each of the paper fiber sheets has a thickness ranging from 0.08-0.12 mm.

4. The window blind component of claim 1, wherein the window blind component is a head rail of a window blind, the number of the paper fiber sheets in the stack is 40-60, and each of the paper fiber sheets has a thickness ranging from 0.08-0.12 mm.

5. The window blind component of claim 1, wherein the window blind component is a bottom rail of a window blind, the number of the paper fiber sheets in the stack is 80-120, and each of the paper fiber sheets has a thickness ranging from 0.08-0.12 mm.

6. A window blind slat, comprising a stack of paper fiber sheets, and an adhesive bonding the paper fiber sheets together, the window blind slat being made by a process which comprises:
(a) preparing the paper fiber sheets at least in an amount of twenty;
(b) applying the adhesive to each of the paper fiber sheets;
(c) stacking the paper fiber sheets together with the adhesive to form a stack, followed by press forming the stack to produce a paper fiber composite material in the form of a non-cellular flat sheet;
(d) heating and drying the paper fiber composite material and cutting the same into a blank; and
(e) forming the blank into the window blind slat;
wherein each of the paper fiber sheets includes 91-95% by weight of paper pulp, 3-5% by weight of a binder, and 2-4% by weight of a water repellent.
